(19) United States
(12) Patent Application Publication
(10) Pub. No.: US 2007/0190264 A1
(43) Pub. Date: Aug. 16, 2007

(54) PRINTED CIRCUIT BOARDS

(75) Inventor: Zhi Hai Zhang, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/675,385

(22) Filed: Feb. 15, 2007

(30) Foreign Application Priority Data
Feb. 16, 2006 (TW) TW95105207

(51) Int. Cl. C08F 2/46

(52) U.S. Cl. 427/487

(57) ABSTRACT

Printed circuit boards are provided. A printed circuit board includes a main body and an anti-EMI coating. The main body includes a substrate and a conductor connected to an electronic component on the substrate. The anti-EMI coating is formed on the substrate or the conductor by printing, plating or deposition, to prevent EMI.

### BACKGROUND OF THE INVENTION

1. Field of the Invention

The invention relates in general to printed circuit boards and in particular to printed circuit boards with anti-EMI coatings for preventing EMI.

2. Description of the Related Art

EMI isolation is important in printed circuit boards because EMI can propagate by conduction and radiation. Conventional EMI isolation is implemented by filters, shields or grounding devices.

Generally, as the filters, shields and grounding devices are additionally mounted on the printed circuit board, extra assembly processes are required. Moreover, such anti-EMI devices usually occupy considerable space, adversely affecting circuit design and increasing dimensions and weight. EMI isolation is also implemented by a large-area grounded isolation layer coated on the printed circuit board. While electronic elements on the printed circuit board are encompassed by the grounded isolation layer to suppress EMI, the EMI isolation efficiency is limited with respect to different frequencies, adversely affecting electronic signal transmission of the printed circuit board.

### BRIEF SUMMARY OF THE INVENTION

Printed circuit boards are provided. A printed circuit board includes a main body and an anti-EMI coating. The main body includes a substrate and a conductor connected to an electronic component on the substrate. The anti-EMI coating is formed on the substrate or the conductor by printing, plating or deposition, to prevent EMI.

### BRIEF DESCRIPTION OF THE DRAWINGS

The invention can be more fully understood by reading the subsequent detailed description and examples with references made to the accompanying drawings, wherein:

FIG. 1 is a perspective diagram of an embodiment of a printed circuit board;

FIG. 2A is a perspective diagram of another embodiment of a printed circuit board;

FIG. 2B is a perspective diagram of another embodiment of a printed circuit board;

FIGS. 3A and 3B are perspective diagrams of another embodiment of a printed circuit board; and

FIG. 4 is a perspective diagram of a plurality of anti-EMI coatings coupled with a circuit system on a substrate.

### DETAILED DESCRIPTION OF THE INVENTION

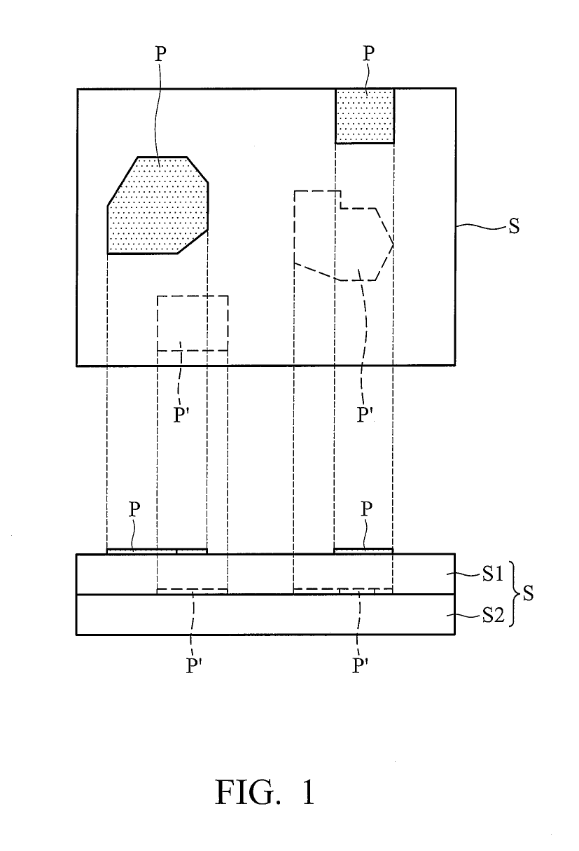

An embodiment of a printed circuit board comprises a main body S and a plurality of anti-EMI coatings P and P′ of specific patterns. As shown in FIG. 1, the anti-EMI coatings P are formed on a surface of the main body S, and the anti-EMI coatings P′ are formed between a substrate S1 and a substrate S2 of the main body S. The anti-EMI coatings P and P′ can be magnetic or dielectric material formed on the main body S or between the substrates of the main body S by printing, plating or deposition, with minimal dimension and thickness.

In some embodiments, the anti-EMI coatings P and P′ are standardized components, each having a specific electrical parameter with respect to different EMI frequencies. The parameters of the anti-EMI coatings P and P′ are considered during circuit design to facilitate EMI isolation of the printed circuit board, with minimal dimension and thickness.

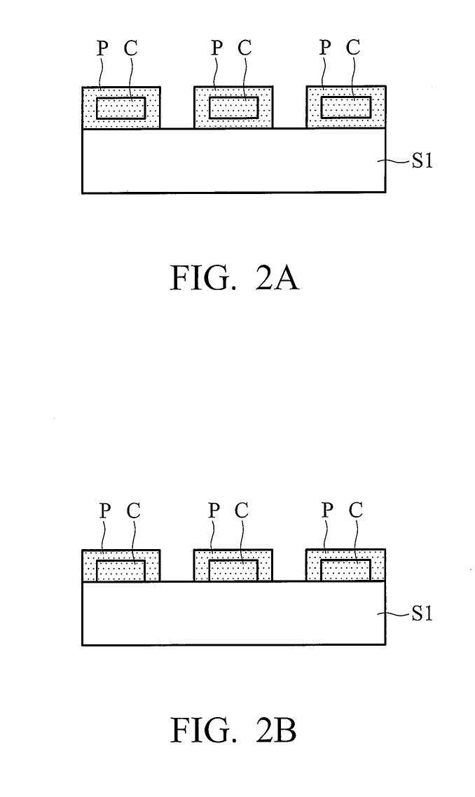

Referring to FIG. 2A, another embodiment of a printed circuit board comprises a substrate S1 with a plurality of conductors C disposed thereon, such as metal traces or electronic components of a circuit. The anti-EMI coatings P are respectively formed around the conductors C by printing, plating or deposition to prevent EMI. Unlike FIG. 2A, the anti-EMI coatings P in FIG. 2B are formed on top and lateral sides of the conductors C and connected to the substrate S1, to prevent EMI.

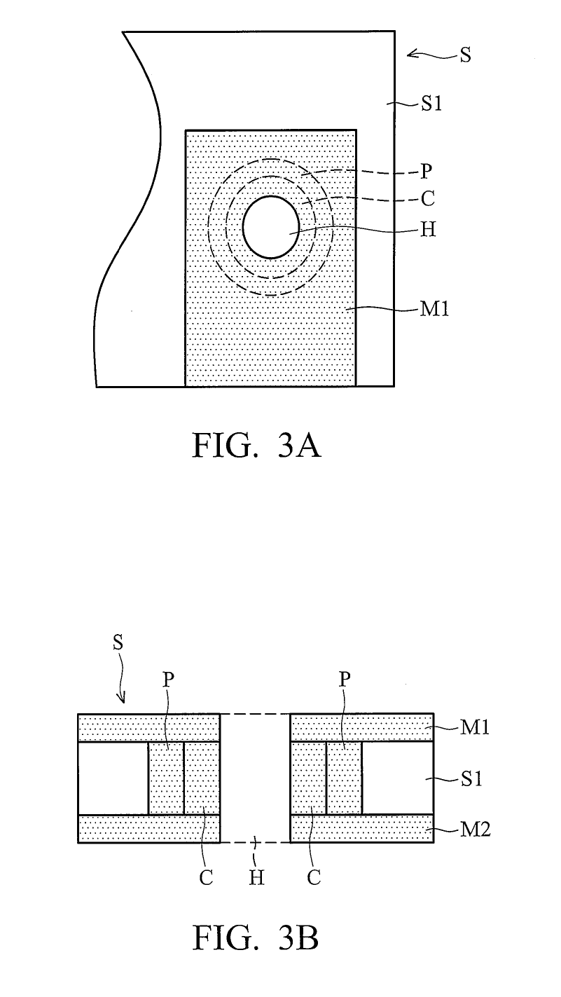

Referring to FIGS. 3A and 3B, another embodiment of a printed circuit board S primarily comprises a first conductive layer M1, a second conductive layer M2, an anti-EMI coating P, a connection hole H and a conductor C, wherein the connection hole H can be a through hole, blind hole or buried hole. As shown in FIGS. 3A and 3B, the conductor C is formed around the connection hole H, electrically connecting the first and second conductive layers M1 and M2. In this embodiment, the anti-EMI coating P is formed around the connection hole H or on the inner surface of the connection hole H by printing, plating or deposition, between the substrate S1 and the conductor C. As the anti-EMI coating P has a tubular structure surrounding the conductor C, EMI is efficiently isolated.

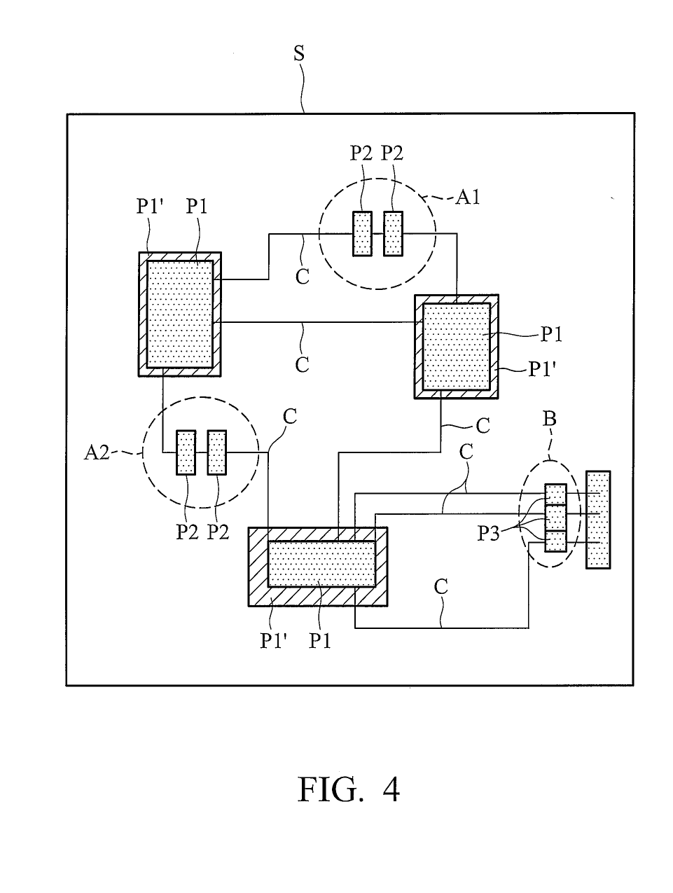

Referring to FIG. 4, another embodiment of a printed circuit board comprises a substrate S and a plurality of anti-EMI coatings P1, P1′, P2 and P3. In this embodiment, the anti-EMI coatings P1, P1′, P2 and P3 can be the same or different standardized components having specific electrical parameters. As shown in FIG. 4, the anti-EMI coatings P1, P1′, P2 and P3 are formed and coupled with a circuit on the substrate S by printing, plating or deposition. Electrical parameters of the circuit and the anti-EMI coatings P1, P1′, P2 and P3 are integrally considered during circuit design of the printed circuit board to prevent EMI, simplifying design complexity and saving space on the printed circuit board.

Specifically, the anti-EMI coatings P1, P1′, P2 and P3 are formed and coupled with the circuit in different ways. In FIG. 4, the anti-EMI coatings P1 and P1′ are stacked, meeting specific thickness and profile requirements by printing, plating or deposition. Thus, EMI of specific frequency can be suppressed by radiation absorption, shielding and frequency filtration. With minimal dimension and thickness of the anti-EMI coatings, circuit design is simplified and dimension of the printed circuit board is considerably reduced.

Referring to portions A1 and A2 in FIG. 4, a plurality of anti-EMI coatings P2 are coupled with a conductor C in series to prevent EMI. Referring to portion B in FIG. 4, a plurality of conductors C and corresponding anti-EMI coatings P3 are coupled in parallel, such that the anti-EMI coatings P3 collectively influence the conductors C to prevent EMI.

In circuit design of the printed circuit board, electrical parameters of the circuit and the anti-EMI coatings P1, P1′, P2 and P3 are integrally considered and calculated to prevent EMI, not only simplifying design complexity but also saving space on the printed circuit board, wherein number and structure of the anti-EMI coatings P1, P1′, P2 and P3 can be appropriately adjusted.

Printed circuit boards having anti-EMI coatings are provided according to the embodiments. In some embodiments, the anti-EMI coatings are formed on/in the printed circuit board by printing, plating or deposition, such that EMI of specific frequency can be suppressed by radiation absorption, shielding and frequency filtration, simplifying circuit design and saving space of the printed circuit board.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A printed circuit board, comprising:
a main body, comprising a substrate and a conductor connected to an electronic component on the substrate; and
an anti-EMI coating, formed on the main body to prevent EMI.

2. The printed circuit board as claimed in claim 1, wherein the anti-EMI coating is formed on the substrate by printing, plating or deposition.

3. The printed circuit board as claimed in claim 1, wherein the anti-EMI coating is formed on the conductor by printing, plating or deposition.

4. The printed circuit board as claimed in claim 1, wherein the anti-EMI coating surrounds the conductor.

5. The printed circuit board as claimed in claim 1, wherein the anti-EMI coating covers the conductor and connects to the substrate.

6. The printed circuit board as claimed in claim 1, wherein the main body comprises a plurality of substrates with the anti-EMI coating disposed therebetweeen.

7. The printed circuit board as claimed in claim 1, the main body comprising a first conductive layer and a second conductive layer, the substrate comprising a connection hole with the conductor disposed therethrough to electrically connect the first and second conductive layers, wherein the anti-EMI coating is disposed around the hole and surrounds the conductor.

8. The printed circuit board as claimed in claim 7, wherein the connection hole is a through hole, blind hole or buried hole.

9. The printed circuit board as claimed in claim 1, further comprising a plurality of standardized anti-EMI coatings with specific electrical parameters, wherein circuits of the printed circuit board are designed according to electrical parameters of the anti-EMI coatings and the conductor.

10. The printed circuit board as claimed in claim 9, wherein the anti-EMI coatings are stacked on the main body.

11. The printed circuit board as claimed in claim 9, wherein the anti-EMI coatings are coupled with the conductor in series.

12. The printed circuit board as claimed in claim 9, the main body comprising a plurality of conductors in parallel, wherein the anti-EMI coatings are correspondingly coupled with the conductors in parallel and collectively influence the conductors.

13. A printed circuit board, comprising:
a main body, comprising a substrate and an electronic circuit disposed on the substrate; and
a plurality of anti-EMI coatings, formed on the main body and coupled with the electronic circuit to prevent EMI.

14. The printed circuit board as claimed in claim 13, wherein the anti-EMI coating is formed on the substrate by printing, plating or deposition.

15. The printed circuit board as claimed in claim 13, wherein the anti-EMI coating is formed on the electronic circuit by printing, plating or deposition.

16. The printed circuit board as claimed in claim 13, wherein the main body comprises a plurality of substrates with the anti-EMI coating disposed therebetweeen.

17. The printed circuit board as claimed in claim 13, further comprising a plurality of standardized anti-EMI coatings with specific electrical parameters, wherein circuits of the printed circuit board are designed according to electrical parameters of the anti-EMI coatings and the electronic circuit.

18. The printed circuit board as claimed in claim 13, wherein the anti-EMI coatings are stacked on the main body.

19. The printed circuit board as claimed in claim 13, wherein the anti-EMI coatings are coupled with the electronic circuit in series.

20. The printed circuit board as claimed in claim 13, the main body comprising a plurality of conductors in parallel, wherein the anti-EMI coatings are correspondingly coupled with the conductors in parallel and collectively influence the conductors.
